(19) United States
(12) Patent Application Publication
(10) Pub. No.: US 2022/0256347 A1
(43) Pub. Date: Aug. 11, 2022

(54) Context Dependent V2X Misbehavior Detection

(71) Applicant: QUALCOMM Incorporated, San Diego, CA (US)

(72) Inventors: Jonathan PETIT, Wenham, MA (US); Cong CHEN, Shrewsbury, MA (US); Mohammad Raashid ANSARI, Lowell, MA (US)

(21) Appl. No.: 17/171,822

(22) Filed: Feb. 9, 2021

(51) Int. Cl. H04W 12/121; H04W 12/63; H04W 4/40; H04W 4/02

(52) U.S. Cl. CPC H04W 12/121; H04W 4/027; H04W 4/40; H04W 12/63

(57) ABSTRACT

Methods, apparatuses, systems, and non-transitory computer-readable media are disclosed for V2X misbehavior detection at a device. A disclosed method comprises performing context detection to generate a determined context for the device. The method further comprises performing a plurality of plausibility checks to generate a plurality of plausibility outputs. At least one plausibility check of the plurality of plausibility checks is performed based on inputs including (1) a reported value obtained from a received V2X message and (2) the determined context for the device. The method further comprises weighing and combining the plurality of plausibility outputs, by applying at least one set of weights based on the determined context for the device, to generate at least one combined, weighted plausibility indicator value. The method further comprises performing at least one misbehavior detection based on the at least one combined, weighted plausibility indicator value, to generate at least one misbehavior detection result.

### BACKGROUND

### Field of Disclosure

Aspects of the disclosure relate to misbehavior detection. More specifically, the disclosure relates to the use of plausibility checks in the detection of misbehavior, such as attacks based on Vehicle-to-everything (V2X) messages.

### Description of Related Art

V2X technology aims to improve traffic safety and efficiency through timely over-the-air exchange of information between vehicle-to-vehicle (V2V) and vehicle-to-infrastructure (V2I). In V2X, vehicles and infrastructure communicate using Basic Safety Messages (BSMs) that are defined in the SAE J2735 standard. A BSM contains situation data, such as the vehicle's location, speed, acceleration, heading, and brake status. V2X technology can thus effectively increases the operator's and vehicle's line-of-sight, creating a safer environment.

### BRIEF SUMMARY

Methods, apparatuses, systems, and non-transitory computer-readable media are disclosed for V2X misbehavior detection at a device. A disclosed method comprises performing context detection to generate a determined context for the device. The method further comprises performing a plurality of plausibility checks to generate a plurality of plausibility outputs. At least one plausibility check of the plurality of plausibility checks is performed based on inputs including (1) a reported value obtained from a received V2X message and (2) the determined context for the device. The method further comprises weighing and combining the plurality of plausibility outputs, by applying at least one set of weights based on the determined context for the device, to generate at least one combined, weighted plausibility indicator value. The method further comprises performing at least one misbehavior detection based on the at least one combined, weighted plausibility indicator value, to generate at least one misbehavior detection result.

A disclosed apparatus comprises a wireless transceiver, a memory, and a processor communicatively coupled to the wireless transceiver and the memory. The processor is configured to perform context detection to generate a determined context for the device. The processor is further configured to perform a plurality of plausibility checks to generate a plurality of plausibility outputs. At least one plausibility check of the plurality of plausibility checks is performed based on inputs including (1) a reported value obtained from a received V2X message and (2) the determined context for the device. The processor is further configured to weigh and combine the plurality of plausibility outputs, by applying at least one set of weights based on the determined context for the device, to generate at least one combined, weighted plausibility indicator value. The processor is further configured to perform at least one misbehavior detection based on the at least one combined, weighted plausibility indicator value, to generate at least one misbehavior detection result.

A disclosed system comprises means for performing context detection to generate a determined context for the device. The system further comprises means for performing a plurality of plausibility checks to generate a plurality of plausibility outputs. At least one plausibility check of the plurality of plausibility checks is performed based on inputs including (1) a reported value obtained from a received V2X message and (2) the determined context for the device. The system further comprises means for weighing and combining the plurality of plausibility outputs, by applying at least one set of weights based on the determined context for the device, to generate at least one combined, weighted plausibility indicator value. The system further comprises means for performing at least one misbehavior detection based on the at least one combined, weighted plausibility indicator value, to generate at least one misbehavior detection result.

A disclosed non-transitory computer-readable medium comprises instructions to perform context detection to generate a determined context for the device. The medium further comprises instructions to perform a plurality of plausibility checks to generate a plurality of plausibility outputs. At least one plausibility check of the plurality of plausibility checks is performed based on inputs including (1) a reported value obtained from a received V2X message and (2) the determined context for the device. The medium further comprises instructions to weigh and combine the plurality of plausibility outputs, by applying at least one set of weights based on the determined context for the device, to generate at least one combined, weighted plausibility indicator value. The medium further comprises instructions to perform at least one misbehavior detection based on the at least one combined, weighted plausibility indicator value, to generate at least one misbehavior detection result.

### BRIEF DESCRIPTION OF THE DRAWINGS

Aspects of the disclosure are illustrated by way of example. In the accompanying figures, like reference numbers indicate similar elements.

FIG. 1 presents an example of a misbehavior detection scheme based on a positional plausibility check that utilizes a determined context as an input, according to an aspect of the disclosure.

FIG. 2 presents another example of the same misbehavior detection scheme based on the positional plausibility check, one that utilizes a different determined context as an input, according to an aspect of the disclosure.

FIG. 3 is a block diagram of a context detection module, according to an aspect of the disclosure.

FIG. 4 presents a multi-layered detection structure for a context detection module such as that presented in FIG. 3.

FIG. 5 is a block diagram of a misbehavior detector utilizing combined, weighted outputs from a plurality of context-dependent plausibility check modules, according to an aspect of the disclosure.

FIG. 6 is a block diagram of an extension of the misbehavior detection system presented in FIG. 5 to support detection of multiple types of misbehaviors, according to an aspect of the disclosure.

FIG. 7 is a flow chart of a process for context-based misbehavior detection, according to an aspect of the disclosure.

FIG. 8 is a block diagram of an on-board unit (OBU) adapted to implement aspects of the present disclosure.

FIG. 9 is a block diagram of various hardware and software components of a vehicle, according to an aspect of the disclosure.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

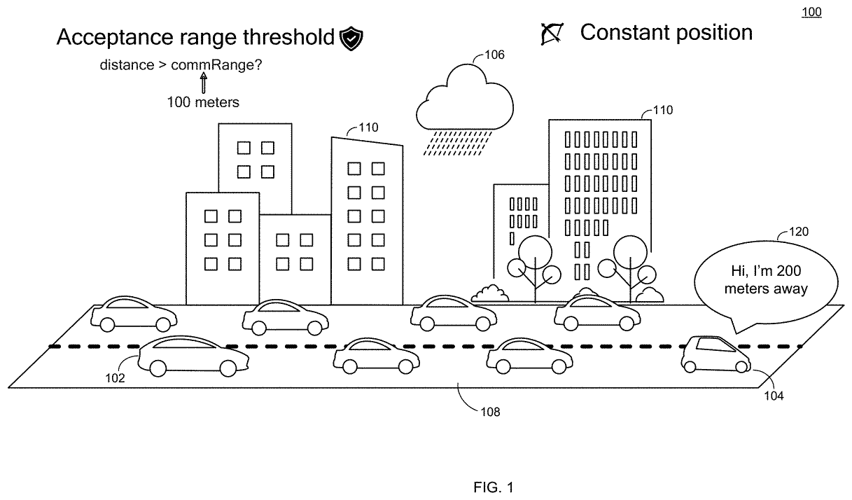

FIG. 1 presents an example of a misbehavior detection scheme based on a positional plausibility check that utilizes a determined context as an input, according to an aspect of the disclosure. An illustrative (non-limiting) driving environment 100 is shown, in which an ego vehicle 102 and a purported remote vehicle 104 are situated. The driving environment 100 is characterized by rainy weather 106, a high-density roadway 108 occupied by many vehicles, and an urban landscape with many structural obstructions such as buildings 110.

The ego vehicle 102 receives a broadcast BSM message 120 from the purported remote vehicle 104. The BSM message 120 includes information indicating the remote vehicle is 200 meters away from the ego vehicle 102. For example, the BSM message 120 may include location information for the remote vehicle 104. The ego vehicle 102 may receive the BSM message 120 and extract the location of the remote vehicle 104. The ego vehicle 102 then determines its own location based on positioning technique such as Global Positioning System (GPS). Based on the two locations, the ego vehicle 102 may determine that the remote vehicle 104 is 200 meters away.

At this point, the ego vehicle 102 may decide whether the BSM message 120 is sent from an actual remote vehicle located 200 meters away or the result of misbehavior—e.g., a bogus BSM message sent as part of a malicious attack. One example of such an attack is a “constant position” attack, in which a purported remote vehicle repeatedly reports its position as being unchanged over multiple BSM messages. A “constant position” attack may simulate a scenario in which a stalled remote vehicle is stranded and stationary in a roadway. The attack can cause traffic slowdowns or stoppages, as vehicles receiving the bogus BSM message slow down or stop in anticipation of encountering the supposed stalled vehicle. However, in reality, no such stalled vehicle exists, and a traffic jam is artificially produced based on the imagined roadway obstacle suggested by the attack. As shown in FIG. 1, such a “constant position” attack is potentially the source of the BSM message 120 received by the ego vehicle 102.

According to an aspect of the disclosure, a misbehavior detector implemented in the ego vehicle 102 may operate to detect misbehavior associated with the BSM message 120 by performing one or more context-dependent plausibility checks. First, the misbehavior detector may perform context detection to generate a determined context for the ego vehicle 102. The determined context may comprise a multi-dimensional value. Just as an example, in the case shown in FIG. 1, the determined context may span across four dimensions: weather, road structure, traffic density, and channel status. In this case, the determined context may be that the weather is “rainy,” the road structure is “urban,” the traffic density is “high,” and the channel status has a congestion score of “8” (e.g., on a scale of 1 to 10, with higher number indicating greater congestion).

Next, the misbehavior detector may perform one or more plausibility checks. Each plausibility check evaluates the plausibility of a certain aspect of the information gathered by the ego vehicle 102. Different classes of plausibility checks may be implemented. For example, one class of plausibility checks may be positional plausibility checks. Positional plausibility checks scrutinize the plausibility of an absolute or relative position of an entity, e.g., the remote vehicle 104.

A specific example of a positional plausibility check is an acceptance range threshold (ART) plausibility check, which is illustrated in FIG. 1. The ART plausibility check compares the purported distance between the ego vehicle 102 and the remote vehicle 104 against a maximum communication range threshold. For example, the V2X transceiver aboard the ego vehicle 102 may have a maximum communication range of 100 meters. In this example, the ART plausibility check may conclude that the purported distance of 200 meters between the ego vehicle 102 and the remote vehicle 104 is not plausible. In other words, it is highly unlikely that the ego vehicle 102 could have received a BSM message 120 from a remote vehicle 104 located 200 meters away, when the maximum possible V2X communication range is only 100 meters.

To improve the performance, thresholds and other characteristics of plausibility checks may be adjustable and made dependent on the determined context, according to aspects of the present disclosure. A determined context may serve as an input to a plausibility check. For example, the maximum communication range threshold, which serves as an input to the ART plausibility check, may be an adjustable value that varies according to the determined context. In the example shown in FIG. 1, the maximum communication range threshold may be set based on the multi-dimensional value of the determined context—e.g., the weather being “rainy,” the road structure is “urban,” the traffic density being “high,” and the channel status having a congestion score of “8.” For instance, rainy weather, high traffic density, and high channel congestion status may all contribute to a relatively lower maximum V2X communication range—i.e., 100 meters in this case.

The ART plausibility check thus compares the remote vehicle 104's purported distance of 200 meters from the ego vehicle 102 to the maximum V2X communication range of 100 meters, and ART plausibility check concludes that it is not plausible that a remote vehicle could have sent a BSM message from such a distance away. The outcome of the ART plausibility check may be a “Fail” or the like. Based on such a positional plausibility check, and potentially other plausibility checks as well, the misbehavior detector implemented in the ego vehicle 102 may decide that the BSM message 120 is attributed to misbehavior (e.g., part of a particular attack), as opposed to a valid BSM message from a real remote vehicle.

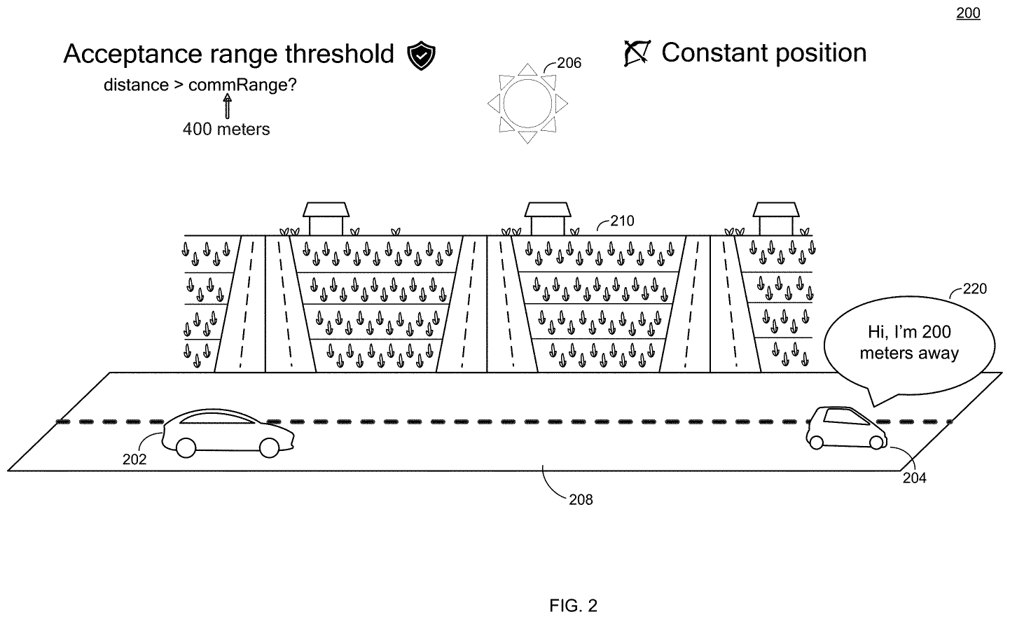

FIG. 2 presents another example of the same misbehavior detection scheme based on the positional plausibility check, one that utilizes a different determined context as an input, according to an aspect of the disclosure. An illustrative driving environment 200 is shown, in which an ego vehicle 202 and a purported remote vehicle 204 are situated. The driving environment 200 is characterized by sunny weather 206, a low-density roadway 208 occupied by very few vehicles, and a rural landscape with few obstructions and open fields 210.

Ego vehicle 202 receives a broadcast BSM message 220 from the purported remote vehicle 204. The BSM message 220 includes information indicating the remote vehicle is 200 meters away from the ego vehicle 202. Similar to the scenario described previously, the BSM message 220 may include location information for the remote vehicle 204. The ego vehicle may receive the BSM message 220 and extract the location of the remote vehicle 204. Again, the ego vehicle then determines its own location based on positioning technique such as Global Positioning System (GPS). Based on the two locations, the ego vehicle 202 may determine that the remote vehicle 204 is 200 meters away.

At this point, the ego vehicle 202 may need to decide whether the BSM message 220 is sent from an actual remote vehicle located 200 meters away or the result of misbehavior—e.g., a bogus BSM message sent as part of a malicious attack. As before, an example of such an attack is a “constant position” attack, in which a purported remote vehicle repeatedly reports its position as being unchanged over multiple BSM messages. As shown in FIG. 2, such a “constant position” attack is potentially the source of the BSM message 220 received by the ego vehicle 202.

Once again, according to an aspect of the disclosure, a misbehavior detector implemented in the ego vehicle 202 may operate to detect misbehavior associated with the BSM message 220 by performing one or more context-dependent plausibility checks. First, the misbehavior detector may perform context detection to generate a determined context for the ego vehicle 202. The determined context may comprise a multi-dimensional value. Here, in the case shown in FIG. 2, the determined context may span across four dimensions. The determined context may be that the weather is “sunny,” the roadway structure is “rural,” the traffic density is “low,” and the channel status has a congestion score of “2” (e.g., on a scale of 1 to 10, with higher number indicating greater congestion).

Next, the misbehavior detector may perform one or more plausibility checks. Each plausibility check evaluates the plausibility of a certain aspect of the information gathered by the ego vehicle 202. Different classes of plausibility checks may be implemented, including positional plausibility checks. The specific example of an acceptance range threshold (ART) plausibility check is used, as in the previous example. The ART plausibility check compares the purported distance between the ego vehicle 202 and the remote vehicle 204 against a maximum communication range threshold.

Again, the maximum communication range threshold, which serves as an input to the ART plausibility check, may be an adjustable value that varies according to the determined context. In the example shown in FIG. 2, the maximum communication range threshold may be set to 400 meters, based on the multi-dimensional value of the determined context—e.g., the weather being “sunny,” the road structure being “rural,” the traffic density being “low,” and the channel status having a congestion score of “2.” Sunny weather, rural road structure, low traffic density, and low channel congestion status may all contribute to a relatively higher maximum V2X communication range—i.e., 400 meters in this case.

The ART plausibility check thus compares the remote vehicle 204's purported distance of 200 meters from the ego vehicle 202, to the maximum V2X communication range of 400, and concludes that it is plausible that a remote vehicle could have sent a BSM message from such a distance away. The outcome of the ART plausibility check may be a “Pass” or the like. Based on such a positional plausibility check, and potentially other plausibility checks as well, the misbehavior detector implemented in the ego vehicle 202 may decide that the BSM message 220 is a valid BSM message from a real remote vehicle and not attributed to misbehavior (e.g., part of a particular attack).

Together, FIGS. 1 and 2 illustrate that an ego vehicle may use the output of a context determination module to adjust an input to one or more plausibility checks. Thus, a plausibility check (and ultimately, a misbehavior detector) can treat an incoming BSM message differently under different contexts. The same BSM message that is deemed by the misbehavior detector to be “misbehavior” and part of an attack under one context (e.g., rainy weather, urban road structure, high traffic density, with a channel congestion score of “8”) may very well be deemed to be a real, legitimate BSM message under a different context (e.g., sunny weather, rural road structure, low traffic density, with a channel congestion score of “2”).

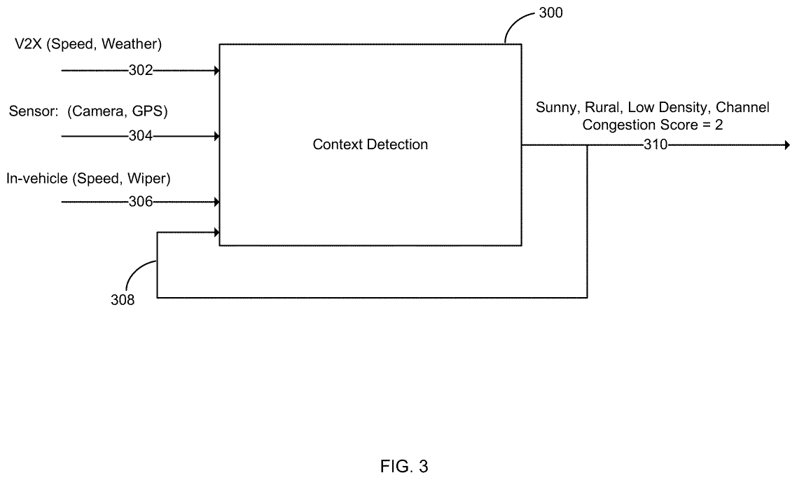

FIG. 3 is a block diagram of an example of a context detection module 300, according to an aspect of the disclosure. As shown, the context detection module 300 may receive multiple inputs, including inputs 302 from the V2X communication system, inputs 304 from various sensors, such as one or more cameras, a GPS system generating location coordinates, etc., inputs 306 from in-vehicle instruments such as a speedometer, wiper system, etc., which can be received from an on-board unit (OBU) of a vehicle, as well as inputs 308 from a feedback path, which is connected to an output 310 of the context detection module 300. The output 310 provides the determined context for the device, e.g., an ego vehicle, based on the inputs 302, 304, 306, and 308. The output 310 may comprise a multi-dimensional value. For example, four different dimensions may correspond to a weather determination (e.g., “Sunny”), a road structure determination (e.g., “Rural”), a traffic density determination (e.g., “Low Density”), and a channel congestion status determination (e.g., “Congestion Score=2”).

The use of a feedback path allows the context detection module 300 to moderate the detection outcome. The determination of a current context takes into account not only current inputs 302, 304, and 306 but also the result of the prior context determination. Such a feedback path provides memory to the module, to temper new and different inputs with past output(s). Thus, the context detection module can reduce abrupt changes to the determined context output. If drastically different inputs are provided at inputs 302, 304, and 306, the degree of change to the output may be moderated by the previous output provided via the feedback path. Eventually, if the different inputs persist, the output 310 may ultimately reach a value that is commensurate with the input values at 302, 304, and 306, but an abrupt change at the output 310 can be avoided. While the feedback path shown in FIG. 3 suggests memory that is one state deep, the context detection module 300 may be implemented with memory for storing outcomes N states deep, where N is a positive integer greater than 1. That is, the context detection module 300 may take into account not only the immediately prior output, but also the past N outputs in time.

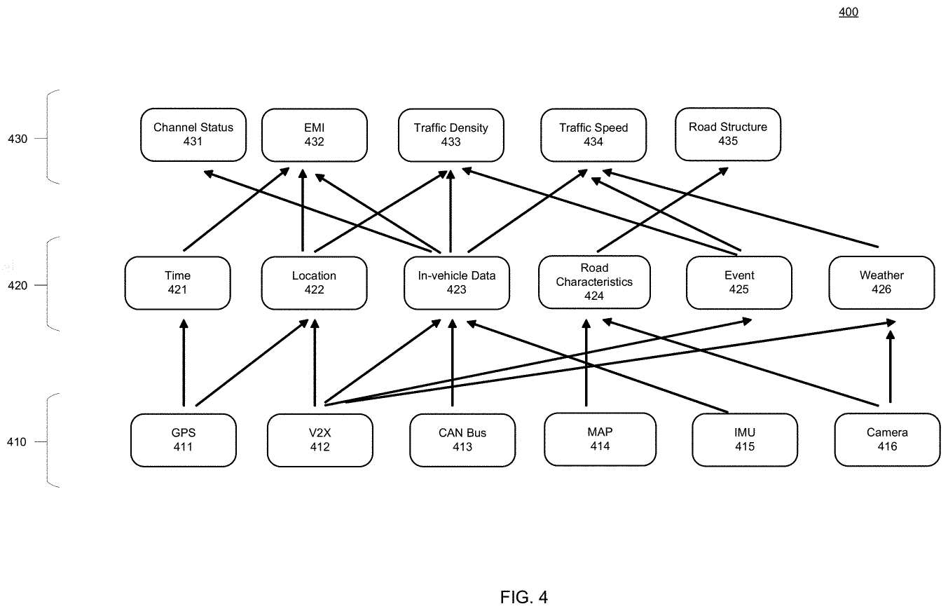

FIG. 4 presents a multi-layered detection structure 400 for a context detection module such as that presented in FIG. 3. The multiple layers illustrate that detection can be based on multiple layers of sub-detectors, which can be interrelated and allow for progressive detection of an environmental context. Three layers of sub-detectors are shown in the figure, i.e., layer 410, layer 420, and layer 430. However, a different number of layers, e.g., less than or more than three layers, can be implemented. The specific sub-detectors in each layer, as described below, are also illustrative and non-limiting in nature.

In the present example, the first layer 410 represents the lowest level of sensors, detectors, or other input information systems available to the structure 400. Here, layer 410 comprises a GPS unit 411 providing GPS coordinates, a V2X communication unit 412 receiving messages such as BSM messages, a controller area network (CAN) bus 413 which serves as the main communication bus connecting main sub-systems within the vehicle, a map module 414 providing downloaded or on-line map information regarding the geographic areas around the vehicle or on a route, an inertial measurement unit (IMU) 415 providing inertial measurements such as specific force, angular rate, orientation, etc., associated with the vehicle's movement, and one more cameras 416 providing images captured from the vehicle. The information provided by the sub-detectors in layer 410 are made available to higher-level sub-detectors in structure 400.

The second layer 420 of sub-detectors includes a time module 421, which may extract time information from the GPS unit, a location module 422 which may determine location coordinates for the vehicle based on GPS coordinate information obtained from GPS unit 411, as well as messages received by V2X communication unit 412. The second level 420 also includes an in-vehicle data module 423, which consolidates information regarding the vehicle from various lower-level detectors such as the V2X communication unit 412, the CAN bus 413, the IMU 415, etc. The second level 420 also includes an event module 425 that detects events relating to road conditions, roadside units, other vehicles, etc., and may be based, e.g., on BSM messages received by the V2X communication unit 412. The second level 420 also includes a road characteristic module 424, which provides a characterization of the roadway traveled by the vehicle, such as “highway,” “local,” “four-lane,” “two-lane with no median,” etc., based on input such as the map module 414 and the camera(s) 416. The second level 420 also includes a weather detection module 426 that can detect weather conditions based on information obtained from lower-level devices, e.g., the V2X communication unit 412 and the one more cameras 416.

The third layer 430 of sub-detectors includes a channel status module 431, which generates status information on the V2X communication channel based on information provided by, e.g., the in-vehicle data module 423. Status information may include, for example, an indication of the level of congestion of the V2X channel. As mentioned, previously, such a congestion indicator score may be based on a numerical scale, e.g., from 1 to 10 with higher number indicating greater congestion. The third layer 430 of sub-detectors may also include an electromagnetic interference (EMI) detector module 432 that predicts/detects the presence of electromagnetic interference. EMI disturbances can be human-made or naturally occurring and include sources such as ignition systems, cellular network of mobile phones, lightning, solar flares, auroras, etc. The EMI detector module 432 may base its determination on inputs such as the time module 421, the location module 422, and the in-vehicle data module 423. The third layer 430 of sub-detectors may also include a traffic density detection module 433, which determines the density of the roadway traversed by the vehicle and may be based on inputs such as the location module 422, the in-vehicle data module 423, and the event module 425. The third layer 430 of sub-detectors can further include a traffic speed module 434, which detects speed information pertaining to traffic surrounding the vehicle, based on inputs such as the in-vehicle data module 423, the events module 425, and the weather module 426. Such speed information may include, e.g., maximum speed, minimum speed, average speed, etc. Finally, the third layer 430 of sub-detectors may also include a road structure module 435, which detects the type of road structure on which the vehicle is traveling, based on inputs such as the road characteristic module 424.

The multi-dimensional context value provided by structure 400 may be selected from one or more of the outputs of the sub-detectors from layers 410, 420, and/or 430. The outputs do not have to all come from the top layer 430. For example, referring to FIG. 3, the context detection module 300 (which may implement multi-layer structure 400) may generate a multi-dimensional context determination reflecting a weather determination (e.g., “Sunny”), a road structure determination (e.g., “Rural”), a traffic density determination (e.g., “Low Density”), and a channel congestion status determination (e.g., “Congestion Score=2”). Here, the weather determination may come from weather module 426, which is from layer 420. The road structure determination, traffic density determination, and the channel congestion status information may come from the road structure module 435, the traffic density module 433, and the channel status module 431, respectively, which are all from layer 430.

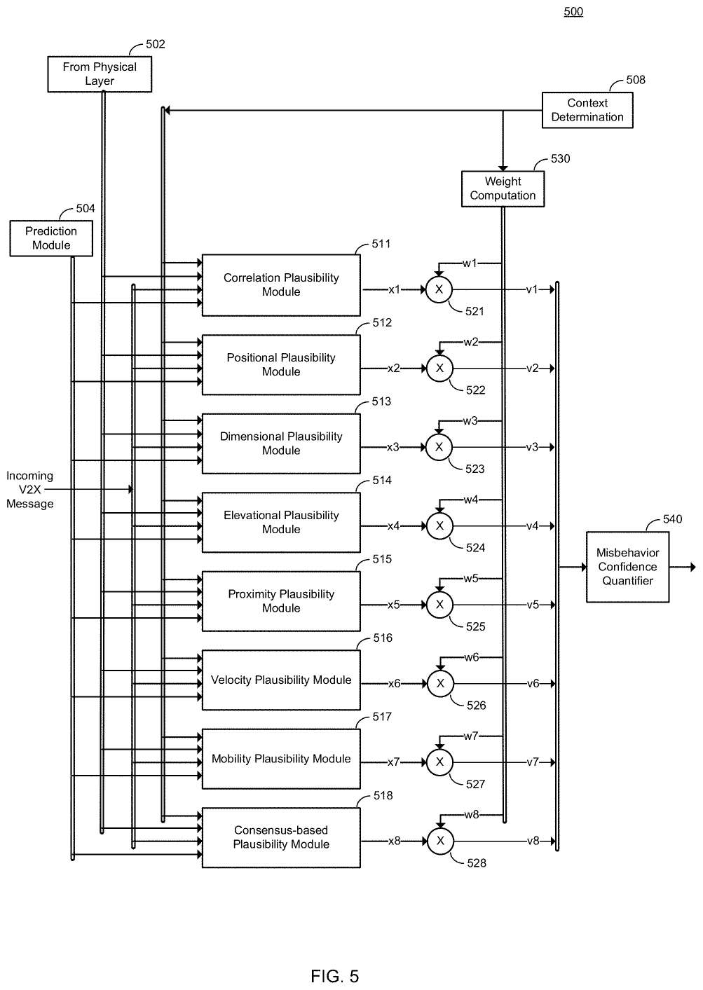

FIG. 5 is a block diagram of a misbehavior detector 500 utilizing combined, weighted outputs from a plurality of context-dependent plausibility check modules, according to an aspect of the disclosure. The misbehavior detector 500 includes inputs and controls such as physical layer signals 502, a prediction module 504, a weight computation module 530, and a context determination module 508. The misbehavior detector 500 also includes plausibility check modules 511, 512, 513, 514, 515, 516, 517, and 518. Finally, the misbehavior detector 500 includes a misbehavior confidence quantifier 540.

Received V2X messages, including especially V2V messages (typically basic safety messages (BSMs)), are shown as being input to plausibility check modules 511, 512, 513, 514, 515, 516, 517, and 518. The modules 511-518 each also receive signals representative of information, from the physical layer (as represented by physical layer signals 502) and from the prediction module 504. The information from the physical layer includes, for example, the direction of arrival and signal strength of received messages. The information from prediction module 504 may include information regarding prior messages and the outputs of, for example, a Kalman filter and/or other known prediction algorithms or routines that determine, from prior messages and other information received from sensors and other available sources, prediction information that is used in computations that determine plausibility in accordance with routines employed by the plausibility check modules 511-518.

According to an aspect of the disclosure, at least one plausibility check of a plurality of plausibility checks is performed based on inputs including (1) a reported value obtained from a received V2X message and (2) the determined context for the device. This is demonstrated by the plausibility check modules 511-518. Here, each of the plausibility check modules 511-518 receives, as input, information from the incoming V2X message. The V2X information may include, for example, the purported location of a remote vehicle, such as remote vehicles 104 in FIG. 1 (or remote vehicle 204 in FIG. 2). Each of the plausibility check modules 511-518 also receives, as input, the determined context generated by the context determination module 508. The context determination module 508 receives various inputs and produces signals representative of settings, conditions, and circumstances in the region surrounding the vehicle. An example of the context determination module 508 is the context detection module 300 in FIG. 3, which may be implemented with a layered detection structure 400 shown in FIG. 4. By providing the determined context as input to the plausibility check modules 511-518, the misbehavior detector 500 allows thresholds and other characteristics of each plausibility checks to be adjustable and made dependent on the determined context, thereby further improving performance.

As mentioned, at least one plausibility check of a plurality of plausibility checks is performed based on inputs including (1) a reported value obtained from a received V2X message and (2) the determined context for the device. Here, the term “inputs” broadly covers both direct and indirect inputs. The determined context may be provided as a direct input and/or an indirect input to the at least one plausibility check. For instance, FIG. 5 presents one embodiment in which each of the plausibility check modules 511-518 receives a direct input from the context determination module 508. In another embodiment, each of the plausibility check modules 511-518 may receive an indirect direct input from the context determination module 508. Just as an example, an intermediate module (not shown) may receive the output of the context determination module 508 and generate weights and/or parameters that are then provided as input to each of the plausibility check modules 511-518, thus providing context information as an indirect input to the plausibility check modules.

The correlation plausibility module 511 operates to find consistency between various parameters in a BSM/V2X message. For example, if brakes have been applied, acceleration should be below zero (negative). If acceleration is not zero, speed should not be zero. The positional plausibility module 512 operates to detect if the location claimed in a BSM is plausible. An example of a positional plausibility check is an acceptance range threshold (ART) check, as mentioned previously. Another example of a positional plausibility check is a sudden appearance (PSA) check. An PSA check may comprise one or more tests, based on one or more sudden appearance test thresholds, to postulate that a transmitter of the V2X message has suddenly appeared. The one or more sudden appearance test thresholds may be set based on the determined context of the device. For instance, if a dimension of the determined context is “Highway,” the SPA check may comprise one or more the following non-limiting tests:
If a message received is the first BSM from a particular sender;
If the position in the BSM is within an assumed communication range (e.g., 400 meters), determined based on the determined context (“Highway”); and
If the position in the BSM is within safety distance of the receiver. Here, since vehicles on a highway usually travel faster, the safety distance may be, e.g., twice the number of seconds required to stop, depending on the ego vehicle's speed.

Other non-limiting examples of positional plausibility checks may include one or more of:
Whether the location is on a road;
If the position is the same as seen in a previous BSM, speed should be zero;
Whether the location overlaps a location sent in a BSM sent by another vehicle. The location overlap check may be context dependent. For example, if the determined context comprises “Highway,” the positional overlap check may be stricter, as the accuracy of GNSS coordinates is generally higher in a highway context (e.g., as compared to a determined context comprising “Local Road”); and
Whether the location in current BSM is consistent with location in a previous BSM, based on speed and acceleration in previous BSM.

The dimensional plausibility detection module 513 detects if the dimensions claimed in a BSM are plausible. This detector can check (but is not limited to), for example, one or more of:
Whether the length and width of a vehicle has changed over time;
Whether the length and width correspond to acceleration and speed information of that type of vehicle; and
Whether abnormal length and width information is being transmitted, e.g., a 4-lane wide vehicle.

The elevational plausibility module 514 operates to detect if the elevation claimed in a BSM is plausible. This detector can check (but is not limited to), for example, one or more of:
Whether a claimed elevation corroborates to a particular location, e.g., elevation claims vehicle is on a bridge whereas no bridge exists in that location; and
Whether a high modulation occurs in elevation values between consecutive BSMs.

The proximity plausibility module 515 operates to detect proximity between vehicles and is similar to positional plausibility. The velocity plausibility module 516 operates to detect if the velocity/speed information correlates to information in same BSM or previous BSMs. For example, if position in consecutive BSMs does not change, the check verifies whether the speed is zero. The velocity plausibility check may be context dependent. For example, if the determined context comprises “Highway,” the plausible speed of the vehicle transmitting the BSM may be checked to be within 2 standard deviations from the mean of speeds of the neighbors in the same lane. On the other hand, if the determined context comprises “Local Road,” the plausible speed may be check to be within a maximum speed, as opposed to being based on the speed of neighboring vehicles, whose speeds can range widely, as some vehicles may be travelling at full speed, other vehicles may be slowing down to make a turn, and other vehicles are stopped at an intersection.

The mobility plausibility module 517 operates to detect whether movements of the vehicle are realistic. One example of a check performed by the mobility plausibility module 517 is a maximum yaw rate check, which checks the maximum turning angle of a remote vehicle (as reported by a BSM transmitted by the remote vehicle). Again, the check may be context dependent. For example, if the determined context comprises “Highway,” the expected movement of a vehicle more or less follows a straight line, within a certain maximum positive (+) or negative (−) turning angle (i.e., yaw rate) at any given moment in time (e.g., to change lanes). The consensus-based plausibility module 518 relies on information from neighboring vehicles. Attributes that can be expected to be shared among neighboring vehicles may be used for building a consensus parameter, e.g., a shared direction of travel, etc., which may be used to as a plausibility check on an individual remote vehicle.

According to an aspect of the disclosure, the misbehavior detector 500 may select a plurality of plausibility checks to be performed, based on the determined context, and disable one or more modules to preclude one or more other plausibility checks from being performed. Such a technique may be especially useful for conserving computational resources and re-direction computational resources to other, more useful tasks. Just as an example, if the determined context comprises “Local Road,” the misbehavior detector 500 may turn off the sudden appearance (SA) check within the positional plausibility module 512. One rationale for such a context-dependent disabling of the SA check may be that sudden appearance of a vehicle is not expected to have adverse effect on the V2X network during local road driving. As such, it is acceptable to turn off the SA check in this context. As another example, if once again the determined context comprises “Local Road,” the misbehavior detector 500 may turn off the maximum yaw rate check within the mobility plausibility module 517. One rationale for such disabling may be that local driving can often involve many changes of direction for vehicles, with large turning angles (e.g., at intersections), so a maximum yaw rate check may not yield particularly useful misbehavior results under such a context.

According to an aspect of the disclosure, the misbehavior detector 500 also weighs and combines the plurality of plausibility outputs generated by the plausibility check modules 511-518, by applying at least one set of weights based on the determined context for the device, to generate at least one combined, weighted plausibility indicator value. For example, the output of the context determination module 508 is received by the weighting computation module 530, which computes the relative significance, for the particular current context, of each plausibility measurement, and outputs respective weights in order to reflect such significance. The plausibility check outputs from plausibility check modules 511, 512, 513, 514, 515, 516, 517, and 518 (respectively designated x1, x2, x3, x4, x5, x6, x7, and x8), are respectively coupled, as an input, to multipliers 521, 522, 523, 524, 525, 526, 527, and 528, each of which receives, as its other input, the particular weighting (respectively designated w1, w2, w3, w4, w5, w6, w7, and w8) to be applied to the plausibility measurement.

The weighted plausibility measurements (designated v1, v2, v3, v4, v5, v6, v7, and v8), here referred to as plausibility indicator values, are output, as a one-dimensional array, to misbehavior confidence quantifier 540 which, in this embodiment, can provide a weighted sum of the input values and/or a count of plausibility indicator values that meet a predetermined criterion, such as exceeding a particular threshold, or a combination of such values to be taken as a misbehavior confidence indicator. According to one aspect of the disclosure, a weighted majority vote may be used to combine the plausibility check outputs x1, x2, x3, x4, x5, x6, x7, and x8 with the weights w1, w2, w3, w4, w5, w6, w7, and w8, to generate the weighted sum. For example, each of the plausibility check outputs x1, x2, x3, x4, x5, x6, x7, and x8 may comprise a binary value (e.g., “0” or “1,” representing “False” or “True”). If a particular plausibility check output x is “0,” then the corresponding weight w does not contribute to the weighted sum. If the particular plausibility check output x is “1,” then the corresponding weight w is added to the weighted sum.

In this manner, the weight computation module 530 and the misbehavior confidence quantifier 540 work together, based on information generated by other modules such as the context determination module 508 and plausibility check modules 511-518, to generate a misbehavior detection result for a particular type of misbehavior. Just as an example, the weight computation module 530 and the misbehavior confidence quantifier 540 may work together to detect a “constant position” attack.

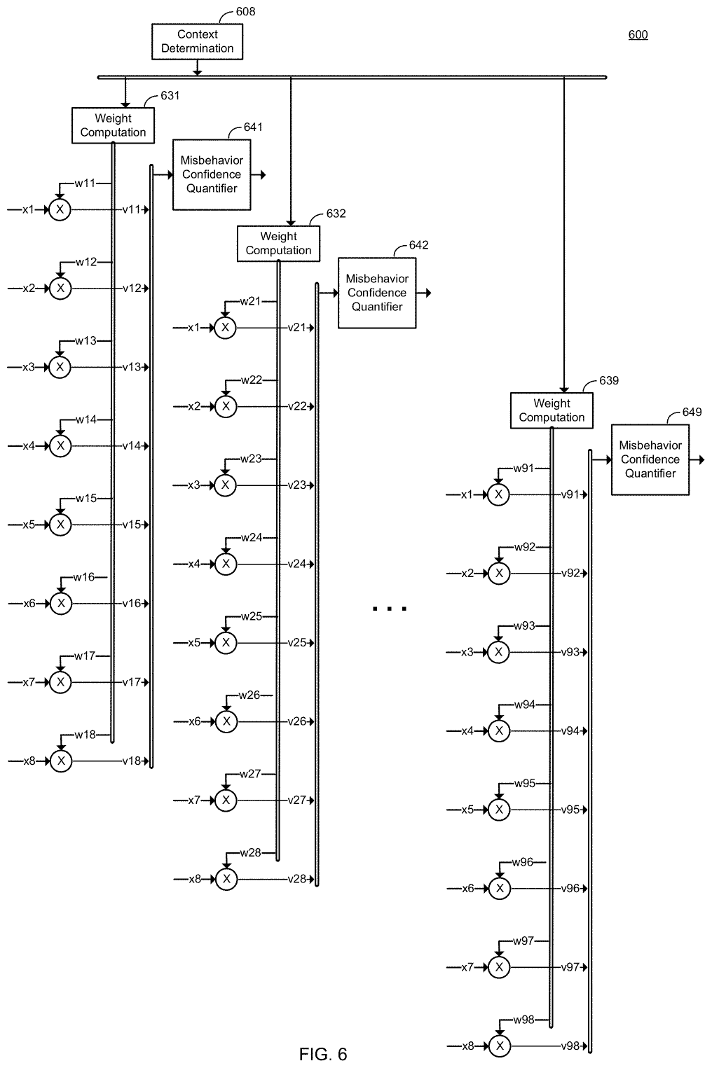

FIG. 6 is a block diagram of an extension 600 of the misbehavior detection system 500 presented in FIG. 5 to support detection of multiple types of misbehaviors, according to an aspect of the disclosure. The determined context 608 may be obtained, for example, from the context determination module 508 shown in FIG. 5. Here, the extension 600 includes multiple pairs of weight computation module and misbehavior confidence quantifier. A first pair comprises a first weight computation module 631 and a first misbehavior confidence quantifier 641. The weight computation module 631 takes the determined context 608 and generates a first set of weights for the plausibility checks, tuned for detection of a first type of misbehavior. These weights are labeled as w11, w12, w13, w14, w15, w16, w17, and w18. A set of multipliers multiplies the plausibility check outputs x1, x2, x3, x4, x5, x6, x7, and x8 generated by the plurality of plausibility check modules 511-518 (FIG. 5) with the corresponding weights w11, w12, w13, w14, w15, w16, w17, and w18, to generate weighted plausibility check outputs v11, v12, v13, v14, v15, v16, v17, and v18, which are used by the misbehavior confidence quantifier 641 to generate a misbehavior detection result for the first type of misbehavior.

A second pair comprises a second weight computation module 632 and a second misbehavior confidence quantifier 642. The weight computation module 632 takes the determined context 608 and generates a second set of weights for the plausibility checks, tuned for detection of a second type of misbehavior. These weights are labeled as w21, w22, w23, w24, w25, w26, w27, and w28. A set of multipliers multiplies the plausibility check outputs x1, x2, x3, x4, x5, x6, x7, and x8 generated by the plurality of plausibility check modules 511-518 (FIG. 5) with the corresponding weights w21, w22, w23, w24, w25, w26, w27, and w28, to generate weighted plausibility check outputs v21, v22, v23, v24, v25, v16, v27, and v28, which are used by the misbehavior confidence quantifier 642 to generate a misbehavior detection result for the second type of misbehavior.

Additional pairs of weight computation module and misbehavior confidence quantifier may be included to detect additional types of misbehavior. The figure shows an Nth pair as comprising an Nth weight computation module 639 and an Nth misbehavior confidence quantifier 649. The weight computation module 639 takes the determined context 608 and generates an Nth set of weights for the plausibility checks, tuned for detection of an Nth type of misbehavior. These weights are labeled as w91, w92, w93, w94, w95, w96, w97, and w98. A set of multipliers multiplies the plausibility check outputs x1, x2, x3, x4, x5, x6, x7, and x8 generated by the plurality of plausibility check modules 511-518 (FIG. 5) with the corresponding weights w91, w92, w93, w94, w95, w96, w97, and w98, to generate weighted plausibility check outputs v91, v92, v93, v94, v95, v96, v97, and v98, which are used by the misbehavior confidence quantifier 649 to generate a misbehavior detection result for the Nth type of misbehavior.

Thus, the misbehavior detector 500 shown in FIG. 5 and extension 600 shown in FIG. 6 may detect multiple, different types of misbehaviors, based on operations that are context dependent. Different types of misbehavior may also have different detection priority depending on the determined context. Just as an example, if the determined context comprises “Highway,” a list of misbehaviors to be detected may include (in order of priority): Emergency Electronic Brake Light (EEBL) attack, sudden appearance attack, position jump attack, ghost vehicle attack, Sybil attack, and position overlap attack. If the determined context comprises “Local Road,” a list of misbehaviors to be detected may include (in order of priority): vehicle erratic mobility attack, position jump attack, sudden appearance attack, ghost vehicle attack, Sybil attack, position overlap attack, and EEBL attack.

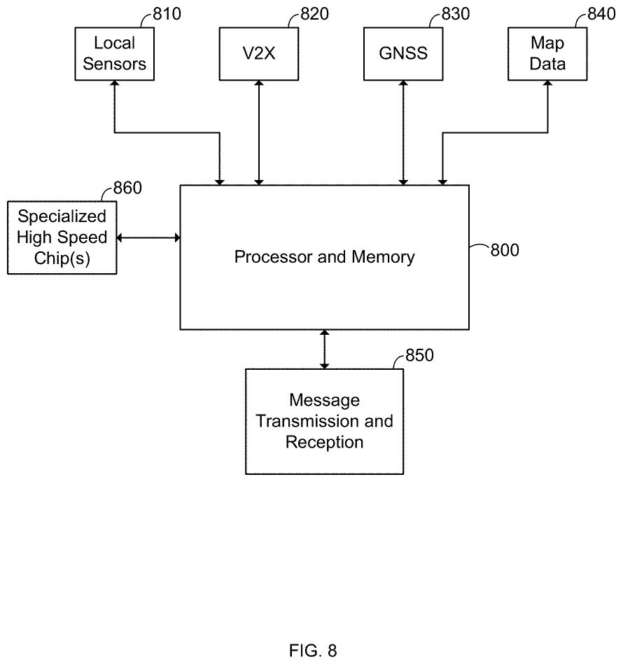

The functions of the misbehavior detector 500 shown in FIG. 5 and extension 600 shown in FIG. 6 can be performed using hardware and/or software implementations. Special-purpose processor modifications of an on-board unit (OBU, see e.g., FIG. 8), such as can be achieved with specialized chips, would provide the substantial advantage of high-speed on-board implementation.

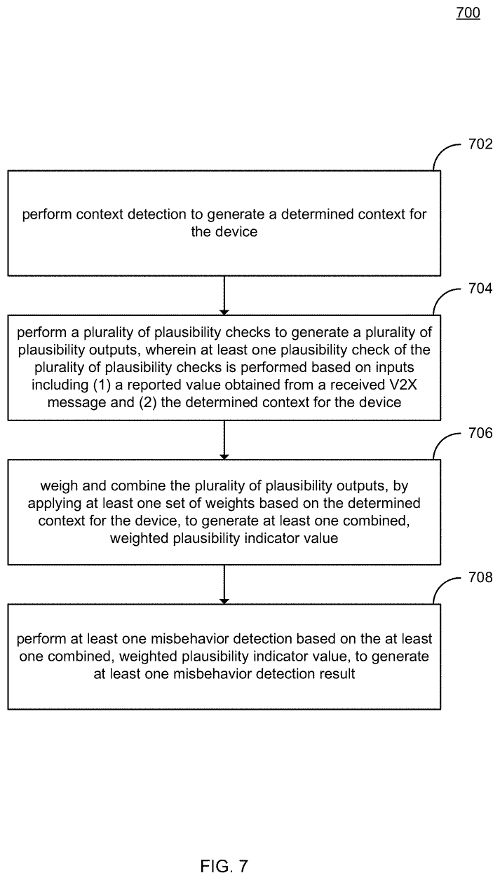

FIG. 7 is a flow chart of a process 700 for context-based misbehavior detection, according to an aspect of the disclosure. The steps illustrated may generally be performed using one or more processors, memory, and programmed instructions provided with a device, as discussed in later sections. Specific operations of each step may be implemented as hardware or software modules as referenced below. At 702, perform context detection is performed to generate a determined context for the device. The context detection may be performed using, for example, the context detection module 300 shown in FIG. 3, e.g., with a layered detection structure 400 shown in FIG. 4.

At 704, a plurality of plausibility checks are performed to generate a plurality of plausibility outputs. In some implementations, at least one plausibility check of the plurality of plausibility checks is performed based on inputs including (1) a reported value obtained from a received V2X message and (2) the determined context for the device. The plurality of plausibility checks may be performed using, for example, the plausibility check modules 511-518 shown in FIG. 5.

At 706, the plurality of plausibility outputs are weighed and combined, by applying at least one set of weights based on the determined context for the device, to generate at least one combined, weighted plausibility indicator value. The plurality of plausibility outputs may be weighed and combined using, for example, the multipliers 521-528, weight computation module 530, and other components of the misbehavior detector 500 shown in FIG. 5, as well as the multipliers, weight computation modules 631, 632, and 639, and other components of the extension 600 shown in FIG. 6.

At 708, at least one misbehavior detection is performed based on the at least one combined, weighted plausibility indicator value, to generate at least one misbehavior detection result. The at least one misbehavior detection may be performed using, for example, the misbehavior confidence quantifier 540 shown in FIG. 5, as well as the misbehavior confidence quantifier 640 shown in FIG. 6.

FIG. 8 is a block diagram of an on-board unit (OBU) 800 adapted to implement aspects of the present disclosure, shown in conjunction with some of the operational subsystems and components of a typical vehicle in a connected vehicle system. Reference can also be made to SAE specification J2945, which sets forth On Board System Requirements for V2V Safety Communications. The central processor unit and memory of the OBU are represented generally at 800. Interacting therewith are, typically, local sensors 810 (including cameras), V2X communication module 820, global navigation satellite system (“GNSS”) 830, map data module 840, and message transmission and receiving subsystem 850. Here, the OBU 800 has been equipped with one or more special purpose high speed chips 860, especially for implementing the misbehavior detection algorithm routines hereof.

The Onboard Unit (OBU) typically sends, receives, and processes messages coming from other vehicles or infrastructure (generally called Vehicle-to-X messages) to improve user's safety, driving experience and road efficiency. IEEE 1609.2 mandates the use of an authentication technique that provides node-centric trust (i.e. an OBU knows the received message is coming from an authorized and authenticated source). However, an OBU may assess the validity of the data being (authentically) transmitted, namely establish data-centric trust. This may be a task of a local misbehavior detection system. The local misbehavior detection system runs on the vehicle system and analyzes incoming and outgoing V2X messages. When a misbehavior is detected, then one option for the misbehavior detection system may generate a misbehavior report that contains the evidence of the misbehavior. The misbehavior report may then be transmitted to a backend server for further analysis. For example, the Security Credential Management System (SCMS), which is a security infrastructure that handles generation and revocation of security credentials, may receive such misbehavior reports to trigger a certificate revocation if deemed necessary. A revoked vehicle, i.e. its security credentials are revoked, may not be able to participate to the network and other entities receiving its messages will dismiss them.

While aspects of the disclosure have been described in the context of vehicles, such as ego vehicle 102 (FIG. 1) and ego vehicle 202 (FIG. 2), the components and techniques described herein can also be implemented in non-vehicle devices, including wireless communication devices (e.g., mobile phones), base stations for wireless communications systems (e.g., eNodeBs), roadside units (RSUs), etc. Wireless communication devices, base stations, RSUs, and other devices may very well receive V2X communications (e.g., BSMs), including V2X communications that potentially are part of misbehavior such as various types of attacks. Thus, aspect of the present disclosure may be deployed by devices including vehicles, wireless communication devices, base stations, RSUs, etc., to detect such misbehavior in an effective manner.

Similarly, while the transmitter of the V2X message potentially associated with misbehavior has been described as being a remote vehicle, such as remote vehicle 104 (FIG. 1) and remote vehicle 204 (FIG. 2), other types of devices can transmit such V2X messages. For example, mobile device carried by a pedestrian can transmit a bogus BSM message designed to appear as if it was sent from a vulnerable road user or even a remote vehicle. Thus, the potentially problematic V2X message may have been received from a remote vehicle, a wireless communication device, a base station, an RSU, etc. It may be less likely that a fixed-location device, such as a base station or RSU, would be the sender of a problematic V2X message, but it is not impossible. For example, a base station or RSU may be hacked, such that it is controlled by an entity that takes over control and implements misbehavior in the form of altered V2X transmissions.

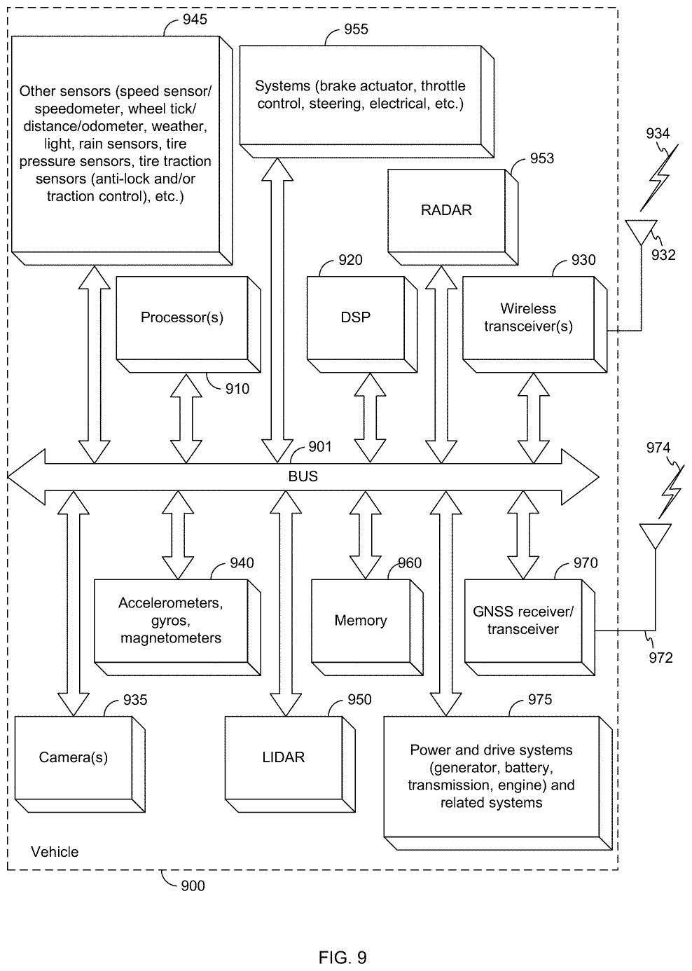

FIG. 9 is a block diagram of various hardware and software components of a vehicle 900, according to an aspect of the disclosure. An example of vehicle 900 may be vehicle 102 shown in FIG. 1 or vehicle 202 shown in FIG. 2. Components and functions of the vehicle 900 may be organized as part of an on-board unit such as OBU 8 shown in FIG. 8. While a vehicle is described here for illustrative purposes, other transceiver receiving V2X communications, such as a device carried by a pedestrian or an infrastructure component, may implement the disclosed techniques for identifying abnormal transmissions. Returning to FIG. 9, vehicle 900 may comprise for example, a car, truck, motorcycle and/or other motorized vehicle, may transmit radio signals to, and receive radio signals from, other vehicles, for example, via V2X car to car communication, and/or from a wireless communication network, base station, and/or wireless access point, etc. In one example, vehicle 900 may communicate, via wireless transceiver(s) 930 and wireless antenna(s) 932 with other vehicles and/or wireless communication networks by transmitting wireless signals to, or receiving wireless signals from a remote wireless transceiver which may comprise another vehicle, a base station (e.g., a NodeB, eNodeB, or gNodeB) or wireless access point, over a wireless communication link.

Similarly, vehicle 900 may transmit wireless signals to, or receive wireless signals from a local transceiver over a wireless communication link, for example, by using a WLAN and/or a PAN wireless transceiver, here represented by one of wireless transceiver(s) 930 and wireless antenna(s) 932. In an embodiment, wireless transceiver(s) 930 may comprise various combinations of WAN, WLAN, and/or PAN transceivers. In an embodiment, wireless transceiver(s) 930 may also comprise a Bluetooth transceiver, a ZigBee transceiver, or other PAN transceiver. In an embodiment, vehicle 900 may transmit wireless signals to, or receive wireless signals from a wireless transceiver 930 on a vehicle 900 over wireless communication link 934. A local transceiver, a WAN wireless transceiver and/or a mobile wireless transceiver may comprise a WAN transceiver, an access point (AP), femtocell, Home Base Station, small cell base station, HNB, HeNB, or gNodeB and may provide access to a wireless local area network (WLAN, e.g., IEEE 802.11 network), a wireless personal area network (PAN, e.g., Bluetooth network) or a cellular network (e.g., an LTE network or other wireless wide area network such as those discussed in the next paragraph). Of course, it should be understood that these are merely examples of networks that may communicate with a vehicle over a wireless link, and claimed subject matter is not limited in this respect. It is also understood that wireless transceiver(s) 930 may be located on various types of vehicles 900, such as boats, ferries, cars, buses, drones, and various transport vehicles. In an embodiment, the vehicle 900 may be utilized for passenger transport, package transport or other purposes. In an embodiment, GNSS signals 974 from GNSS Satellites are utilized by vehicle 900 for location determination and/or for the determination of GNSS signal parameters and demodulated data. In an embodiment, signals 934 from WAN transceiver(s), WLAN and/or PAN local transceivers are used for location determination, alone or in combination with GNSS signals 974.

Examples of network technologies that may support wireless transceivers 930 are GSM, CDMA, WCDMA, LTE, 5G or New Radio Access Technology (NR), HRPD, and V2X car-to-car communication. As noted, V2X communication protocols may be defined in various standards such as SAE and ETS-ITS standards. GSM, WCDMA and LTE are technologies defined by 3GPP. CDMA and HRPD are technologies defined by the 3rd Generation Partnership Project II (3GPP2). WCDMA is also part of the Universal Mobile Telecommunications System (UMTS) and may be supported by an HNB.

Wireless transceivers 930 may communicate with communications networks via WAN wireless base stations which may comprise deployments of equipment providing subscriber access to a wireless telecommunication network for a service (e.g., under a service contract). Here, a WAN wireless base station may perform functions of a WAN or cell base station in servicing subscriber devices within a cell determined based, at least in part, on a range at which the WAN wireless base station is capable of providing access service. Examples of WAN base stations include GSM, WCDMA, LTE, CDMA, HRPD, Wi-Fi, Bluetooth, WiMAX, 5G NR base stations. In an embodiment, further wireless base stations may comprise a WLAN and/or PAN transceiver.

In an embodiment, vehicle 900 may contain one or more cameras 935. In an embodiment, the camera may comprise a camera sensor and mounting assembly. Different mounting assemblies may be used for different cameras on vehicle 900. For example, front facing cameras may be mounted in the front bumper, in the stem of the rear-view mirror assembly or in other front facing areas of the vehicle 900. Rear facing cameras may be mounted in the rear bumper/fender, on the rear windshield, on the trunk or other rear facing areas of the vehicle. The side facing mirrors may be mounted on the side of the vehicle such as being integrated into the mirror assembly or door assemblies. The cameras may provide object detection and distance estimation, particularly for objects of known size and/or shape (e.g., a stop sign and a license plate both have standardized size and shape) and may also provide information regarding rotational motion relative to the axis of the vehicle such as during a turn. When used in concert with the other sensors, the cameras may both be calibrated through the use of other systems such as through the use of LIDAR, wheel tick/distance sensors, and/or GNSS to verify distance traveled and angular orientation. The cameras may similarly be used to verify and calibrate the other systems to verify that distance measurements are correct, for example by calibrating against known distances between known objects (landmarks, roadside markers, road mile markers, etc.) and also to verify that object detection is performed accurately such that objects are accordingly mapped to the correct locations relative to the car by LIDAR and other system. Similarly, when combined with, for example, accelerometers, impact time with road hazards, may be estimated (elapsed time before hitting a pot hole for example) which may be verified against actual time of impact and/or verified against stopping models (for example, compared against the estimated stopping distance if attempting to stop before hitting an object) and/or maneuvering models (verifying whether current estimates for turning radius at current speed and/or a measure of maneuverability at current speed are accurate in the current conditions and modified accordingly to update estimated parameters based on camera and other sensor measurements).

Accelerometers, gyros and magnetometers 940, in an embodiment, may be utilized to provide and/or verify motion and directional information. Accelerometers and gyros may be utilized to monitor wheel and drive train performance. Accelerometers, in an embodiment, may also be utilized to verify actual time of impact with road hazards such as potholes relative to predicted times based on existing stopping and acceleration models as well as steering models. Gyros and magnetometers may, in an embodiment, be utilized to measure rotational status of the vehicle as well as orientation relative to magnetic north, respectively, and to measure and calibrate estimates and/or models for turning radius at current speed and/or a measure of maneuverability at current speed, particularly when used in concert with measurements from other external and internal sensors such as other sensors 945 such as speed sensors, wheel tick sensors, and/or odometer measurements.

LIDAR 950 uses pulsed laser light to measure ranges to objects. While cameras may be used for object detection, LIDAR 950 provides a means, to detect the distances (and orientations) of the objects with more certainty, especially in regard to objects of unknown size and shape. LIDAR 950 measurements may also be used to estimate rate of travel, vector directions, relative position and stopping distance by providing accurate distance measurements and delta distance measurements.

Memory 960 may be utilized with processor 910 and/or DSP 920, which may comprise Random Access Memory (RAM), Read-Only Memory (ROM), disc drive, FLASH, or other memory devices or various combinations thereof. In an embodiment, memory 960 may contain instructions to implement various methods described throughout this description including, for example, processes to implement the use of relative positioning between vehicles and between vehicles and external reference objects such as roadside units. In an embodiment, memory may contain instructions for operating and calibrating sensors, and for receiving map, weather, vehicular (both vehicle 900 and surrounding vehicles, e.g., HV 110 and RVs 130) and other data, and utilizing various internal and external sensor measurements and received data and measurements to determine driving parameters such as relative position, absolute position, stopping distance, acceleration and turning radius at current speed and/or maneuverability at current speed, inter-car distance, turn initiation/timing and performance, and initiation/timing of driving operations.

In an embodiment, power and drive systems (generator, battery, transmission, engine) and related systems 975 and systems (brake, actuator, throttle control, steering, and electrical) 955 may be controlled by the processor(s) and/or hardware or software or by an operator of the vehicle or by some combination thereof. The systems (brake, actuator, throttle control, steering, electrical, etc.) 955 and power and drive or other systems 975 may be utilized in conjunction with performance parameters and operational parameters, to enable autonomously (and manually, relative to alerts and emergency overrides/braking/stopping) driving and operating a vehicle 900 safely and accurately, such as to safely, effectively and efficiently merge into traffic, stop, accelerate and otherwise operate the vehicle 900. In an embodiment, input from the various sensor systems such as camera 935, accelerometers, gyros and magnetometers 940, LIDAR 950, GNSS receiver/transceiver/transceiver 970, RADAR 953, input, messaging and/or measurements from wireless transceiver(s) 930 and/or other sensors 945 or various combinations thereof, may be utilized by processor 910 and/or DSP 920 or other processing systems to control power and drive systems 975 and systems (brake actuator, throttle control, steering, electrical, etc.) 955.

A global navigation satellite system (GNSS) receiver 970 may be utilized to determine position relative to the earth (absolute position) and, when used with other information such as measurements from other objects and/or mapping data, to determine position relative to other objects such as relative to other vehicles and/or relative to the road surface. To determine position, the GNSS receiver/transceiver/transceiver 970, may receive RF signals 974 from GNSS satellites using one or more antennas 972 (which, depending on functional requirements, may be the same as antennas 932). The GNSS receiver/transceiver/transceiver 970 may support one or more GNSS constellations as well as other satellite-based navigation systems. For example, in an embodiment, GNSS receiver/transceiver/transceiver 970 may support global navigation satellite systems such as GPS, the GLONASS, Galileo, and/or BeiDou, or any combination thereof. In an embodiment, GNSS receiver/transceiver 970 may support regional navigation satellite systems such as NavIC or QZSS or a combination thereof as well as various augmentation systems (e.g., Satellite Based Augmentation Systems (SBAS) or ground based augmentation systems (GBAS)) such as Doppler Orbitography and Radio-positioning Integrated by Satellite (DORIS) or wide area augmentation system (WAAS) or the European geostationary navigation overlay service (EGNOS) or the multi-functional satellite augmentation system (MSAS) or the local area augmentation system (LAAS). In an embodiment, GNSS receiver/transceiver(s) 930 and antenna(s) 932 may support multiple bands and sub-bands such as GPS L1, L2 and L5 bands, Galileo E1, E5, and E6 bands, Compass (BeiDou) B1, B3 and B2 bands, GLONASS G1, G2 and G3 bands, and QZSS L1C, L2C and L5-Q bands.

The GNSS receiver/transceiver 970 may be used to determine location and relative location which may be utilized for location, navigation, and to calibrate other sensors, when appropriate, such as for determining distance between two time points in clear sky conditions and using the distance data to calibrate other sensors such as the odometer and/or LIDAR. In an embodiment, GNSS-based relative locations, based on, for example shared Doppler and/or pseudorange measurements between vehicles, may be used to determine highly accurate distances between two vehicles, and when combined with vehicle information such as shape and model information and GNSS antenna location, may be used to calibrate, validate and/or affect the confidence level associated with information from LIDAR, camera, RADAR, SONAR and other distance estimation techniques. GNSS Doppler measurements may also be utilized to determine linear motion and rotational motion of the vehicle or of the vehicle relative to another vehicle, which may be utilized in conjunction with gyro and/or magnetometer and other sensor systems to maintain calibration of those systems based upon measured location data. Relative GNSS positional data may also be combined with high confidence absolute locations from RSUs, to determine high confidence absolute locations of the vehicle. Furthermore, relative GNSS positional data may be used during inclement weather that may obscure LIDAR and/or camera-based data sources to avoid other vehicles and to stay in the lane or other allocated road area. For example, using an RSU equipped with GNSS receiver/transceiver and V2X capability, GNSS measurement data may be provided to the vehicle, which, if provided with an absolute location of the RSU, may be used to navigate the vehicle relative to a map, keeping the vehicle in lane and/or on the road, in spite of lack of visibility.

RADAR 953, uses transmitted radio waves that are reflected off of objects. The reflected radio waves are analyzed, based on the time taken for reflections to arrive and other signal characteristics of the reflected waves to determine the location of nearby objects. RADAR 953 may be utilized to detect the location of nearby cars, roadside objects (signs, other vehicles, pedestrians, etc.) and will generally enable detection of objects even if there is obscuring weather such as snow, rail or hail. Thus, RADAR 953 may be used to complement LIDAR 950 systems and camera 935 systems in providing ranging information to other objects by providing ranging and distance measurements and information when visual-based systems typically fail. Furthermore, RADAR 953 may be utilized to calibrate and/or sanity check other systems such as LIDAR 950 and camera 935. Ranging measurements from RADAR 953 may be utilized to determine/measure stopping distance at current speed, acceleration, maneuverability at current speed and/or turning radius at current speed and/or a measure of maneuverability at current speed. In some systems, ground penetrating RADAR may also be used to track road surfaces via, for example, RADAR-reflective markers on the road surface or terrain features such as ditches.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory (e.g., memory 960 of FIG. 9) can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. The term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

Implementation examples are described in the following numbered clauses:

Clause 1. A method for V2X misbehavior detection at a device comprising:
performing context detection to generate a determined context for the device;
performing a plurality of plausibility checks to generate a plurality of plausibility outputs, wherein at least one plausibility check of the plurality of plausibility checks is performed based on inputs including (1) a reported value obtained from a received V2X message and (2) the determined context for the device;
weighing and combining the plurality of plausibility outputs, by applying at least one set of weights based on the determined context for the device, to generate at least one combined, weighted plausibility indicator value; and
performing at least one misbehavior detection based on the at least one combined, weighted plausibility indicator value, to generate at least one misbehavior detection result.

Clause 2. The method of clause 1, wherein the determined context for the device comprises a multi-dimensional value.

Clause 3. The method of any of clauses 1-2, wherein performing the context detection to generate the determined context for the device comprises:
receiving a plurality of contextual inputs;
receiving a prior determined context for the device via a feedback path; and
generating the determined context for the device based on the plurality of contextual inputs and the prior determined context for the device.

Clause 4. The method of any of clauses 1-3, wherein:
the at least one plausibility check comprises at least one of a correlation plausibility check, a positional plausibility check, a dimensional plausibility check, an elevational plausibility check, a proximity plausibility check, a velocity plausibility check, a mobility plausibility check, or a consensus-based plausibility check, and
the at least one plausibility check is based on at least one threshold, the at least one threshold being set based on the determined context for the device.

Clause 5. The method of clause 4, wherein:
the positional plausibility check comprises an acceptance range threshold check, the acceptance range threshold check comprises comparing (1) a purported distance between the device and a transmitter of the V2X message, based on a reported position value obtained from the received V2X message and (2) an acceptance range threshold, and
the acceptance range threshold is set based on the determined context for the device.

Clause 6. The method of clause 5, wherein:
the acceptance range threshold is adjusted to a first level upon the determined context for the device attaining a first value, and
the acceptance range threshold is adjusted to a second level upon the determined context for the device attaining a second value.

Clause 7. The method of clause 4, wherein:
the proximity plausibility check comprises a sudden appearance check,
the sudden appearance check comprises one or more tests, based on one or more sudden appearance test thresholds, to postulate that a transmitter of the V2X message has suddenly appeared, and
the one or more sudden appearance test thresholds are set based on the determined context of the device.

Clause 8. The method of any of clauses 1-7, wherein weighing and combining the plurality of plausibility outputs comprises applying a weighted majority vote.

Clause 9. The method of any of clauses 1-8, further comprising:
selecting the plurality of plausibility checks to be performed, based on the determined context for the device;
disabling one or more modules to preclude one or more other plausibility checks from being performed.

Clause 10. The method of any of clauses 1-9, wherein:
the at least one set of weights comprises a plurality of sets of weights,
the at least one misbehavior detection comprise a plurality of misbehavior detections,
each misbehavior detection from the plurality of misbehavior detections is based on a different combined, weighted plausibility indicator value and utilizes a different set of weights from the plurality of sets of weights.

Clause 11. The method of any of clauses 1-10, wherein the device is part of an ego vehicle.

Clause 12. The method of any of clauses 1-11, wherein the V2X message is received from a remote vehicle.

Clause 13. An apparatus for V2X misbehavior detection at a device comprising:
a wireless transceiver;
a memory; and
   a processor communicatively coupled to the wireless transceiver and the memory, wherein the processor is configured to:
perform context detection to generate a determined context for the device;
perform a plurality of plausibility checks to generate a plurality of plausibility outputs, wherein at least one plausibility check of the plurality of plausibility checks is performed based on inputs including (1) a reported value obtained from a received V2X message and (2) the determined context for the device;
weigh and combine the plurality of plausibility outputs, by applying at least one set of weights based on the determined context for the device, to generate at least one combined, weighted plausibility indicator value; and
perform at least one misbehavior detection based on the at least one combined, weighted plausibility indicator value, to generate at least one misbehavior detection result.

Clause 14. The apparatus of clause 13, wherein the determined context for the device comprises a multi-dimensional value.

Clause 15. The apparatus of any of clauses 13-14, wherein the processor is configured to perform the context detection to generate the determined context for the device by:
receiving a plurality of contextual inputs;
receiving a prior determined context for the device via a feedback path; and
generating the determined context for the device based on the plurality of contextual inputs and the prior determined context for the device.

Clause 16. The apparatus of any of clauses 13-15, wherein:
the at least one plausibility check comprises at least one of a correlation plausibility check, a positional plausibility check, a dimensional plausibility check, an elevational plausibility check, a proximity plausibility check, a velocity plausibility check, a mobility plausibility check, or a consensus-based plausibility check, and
the at least one plausibility check is based on at least one threshold, the at least one threshold being set based on the determined context for the device.

Clause 17. The apparatus of clause 16, wherein:
the positional plausibility check comprises an acceptance range threshold check,
the acceptance range threshold check comprises comparing (1) a purported distance between the device and a transmitter of the V2X message, based on a reported position value obtained from the received V2X message and (2) an acceptance range threshold, and
the acceptance range threshold is set based on the determined context for the device.

18 The apparatus of clause 17, wherein:
the acceptance range threshold is adjusted to a first level upon the determined context for the device attaining a first value, and the acceptance range threshold is adjusted to a second level upon the determined context for the device attaining a second value.

Clause 19. The apparatus of clause 16, wherein:
the proximity plausibility check comprises a sudden appearance check,
the sudden appearance check comprises one or more tests, based on one or more sudden appearance test thresholds, to postulate that a transmitter of the V2X message has suddenly appeared, and
the one or more sudden appearance test thresholds are set based on the determined context of the device.

Clause 20. The apparatus of any of clauses 13-19, wherein the processor is configured to weigh and combine the plurality of plausibility outputs by applying a weighted majority vote.

Clause 21. The apparatus of any of clauses 13-20, wherein the processor is further configured to:
select the plurality of plausibility checks to be performed, based on the determined context for the device;
disable one or more modules to preclude one or more other plausibility checks from being performed.

Clause 22. The apparatus of any of clauses 13-21, wherein:
the at least one set of weights comprises a plurality of sets of weights,
the at least one misbehavior detection comprise a plurality of misbehavior detections,
each misbehavior detection from the plurality of misbehavior detections is based on a different combined, weighted plausibility indicator value and utilizes a different set of weights from the plurality of sets of weights.

Clause 23. The apparatus of any of clauses 13-22, wherein the device is part of an ego vehicle.

Clause 24. The apparatus of any of clauses 13-23, wherein the V2X message is received from a remote vehicle.

Clause 25. A system for V2X misbehavior detection at a device comprising:
means for performing context detection to generate a determined context for the device;
means for performing a plurality of plausibility checks to generate a plurality of plausibility outputs, wherein at least one plausibility check of the plurality of plausibility checks is performed based on inputs including (1) a reported value obtained from a received V2X message and (2) the determined context for the device;
means for weighing and combining the plurality of plausibility outputs, by applying at least one set of weights based on the determined context for the device, to generate at least one combined, weighted plausibility indicator value; and
means for performing at least one misbehavior detection based on the at least one combined, weighted plausibility indicator value, to generate at least one misbehavior detection result.

Clause 26. The system of clause 25, wherein the determined context for the device comprises a multi-dimensional value.

Clause 27. The system of any of clauses 25-26, wherein the means for performing the context detection to generate the determined context for the device comprises:
means for receiving a plurality of contextual inputs;
means for receiving a prior determined context for the device via a feedback path; and
means for generating the determined context for the device based on the plurality of contextual inputs and the prior determined context for the device.

Clause 28. A non-transitory computer-readable medium containing instruction therein for execution by one or more processing units for V2X misbehavior detection at a device, comprising instructions to:
perform context detection to generate a determined context for the device;
perform a plurality of plausibility checks to generate a plurality of plausibility outputs, wherein at least one plausibility check of the plurality of plausibility checks is performed based on inputs including (1) a reported value obtained from a received V2X message and (2) the determined context for the device;
weigh and combine the plurality of plausibility outputs, by applying at least one set of weights based on the determined context for the device, to generate at least one combined, weighted plausibility indicator value; and
perform at least one misbehavior detection based on the at least one combined, weighted plausibility indicator value, to generate at least one misbehavior detection result.

Clause 29. The non-transitory computer-readable medium of clause 28, wherein the determined context for the device comprises a multi-dimensional value.

Clause 30. The non-transitory computer-readable medium of any of clauses 28-29, wherein the instruction to perform the context detection to generate the determined context for the device comprises instructions to:
receive a plurality of contextual inputs;
received a prior determined context for the device via a feedback path; and
generate the determined context for the device based on the plurality of contextual inputs and the prior determined context for the device.

1. A method for V2X misbehavior detection at a device comprising:
performing context detection to generate a determined context for the device;
performing a plurality of plausibility checks to generate a plurality of plausibility outputs, wherein at least one plausibility check of the plurality of plausibility checks is performed based on inputs including (1) a reported value obtained from a received V2X message and (2) the determined context for the device;
weighing and combining the plurality of plausibility outputs, by applying at least one set of weights based on the determined context for the device, to generate at least one combined, weighted plausibility indicator value; and
performing at least one misbehavior detection based on the at least one combined, weighted plausibility indicator value, to generate at least one misbehavior detection result.

2. The method of claim 1, wherein the determined context for the device comprises a multi-dimensional value.

3. The method of claim 1, wherein performing the context detection to generate the determined context for the device comprises:
receiving a plurality of contextual inputs;
receiving a prior determined context for the device via a feedback path; and
generating the determined context for the device based on the plurality of contextual inputs and the prior determined context for the device.

4. The method of claim 1, wherein:
the at least one plausibility check comprises at least one of a correlation plausibility check, a positional plausibility check, a dimensional plausibility check, an elevational plausibility check, a proximity plausibility check, a velocity plausibility check, a mobility plausibility check, or a consensus-based plausibility check, and
the at least one plausibility check is based on at least one threshold, the at least one threshold being set based on the determined context for the device.

5. The method of claim 4, wherein:
the positional plausibility check comprises an acceptance range threshold check,
the acceptance range threshold check comprises comparing (1) a purported distance between the device and a transmitter of the V2X message, based on a reported position value obtained from the received V2X message and (2) an acceptance range threshold, and
the acceptance range threshold is set based on the determined context for the device.

6. The method of claim 5, wherein:
the acceptance range threshold is adjusted to a first level upon the determined context for the device attaining a first value, and
the acceptance range threshold is adjusted to a second level upon the determined context for the device attaining a second value.

7. The method of claim 4, wherein:
the proximity plausibility check comprises a sudden appearance check,
the sudden appearance check comprises one or more tests, based on one or more sudden appearance test thresholds, to postulate that a transmitter of the V2X message has suddenly appeared, and
the one or more sudden appearance test thresholds are set based on the determined context of the device.

8. The method of claim 1, wherein weighing and combining the plurality of plausibility outputs comprises applying a weighted majority vote.

9. The method of claim 1, further comprising:
selecting the plurality of plausibility checks to be performed, based on the determined context for the device;
disabling one or more modules to preclude one or more other plausibility checks from being performed.

10. The method of claim 1, wherein:
the at least one set of weights comprises a plurality of sets of weights,
the at least one misbehavior detection comprise a plurality of misbehavior detections,
each misbehavior detection from the plurality of misbehavior detections is based on a different combined, weighted plausibility indicator value and utilizes a different set of weights from the plurality of sets of weights.

11. The method of claim 1, wherein the device is part of an ego vehicle, a wireless communication device, a base station, or a roadside unit (RSU).

12. The method of claim 1, wherein the V2X message is received from a remote vehicle, a wireless communication device, a base station, or a roadside unit (RSU).

13. An apparatus for V2X misbehavior detection at a device comprising:
a wireless transceiver;
a memory; and
a processor communicatively coupled to the wireless transceiver and the memory, wherein the processor is configured to:
perform context detection to generate a determined context for the device;
perform a plurality of plausibility checks to generate a plurality of plausibility outputs, wherein at least one plausibility check of the plurality of plausibility checks is performed based on inputs including (1) a reported value obtained from a received V2X message and (2) the determined context for the device;
weigh and combine the plurality of plausibility outputs, by applying at least one set of weights based on the determined context for the device, to generate at least one combined, weighted plausibility indicator value; and
perform at least one misbehavior detection based on the at least one combined, weighted plausibility indicator value, to generate at least one misbehavior detection result.

14. The apparatus of claim 13, wherein the determined context for the device comprises a multi-dimensional value.

15. The apparatus of claim 13, wherein the processor is configured to perform the context detection to generate the determined context for the device by:
receiving a plurality of contextual inputs;
receiving a prior determined context for the device via a feedback path; and
generating the determined context for the device based on the plurality of contextual inputs and the prior determined context for the device.

16. The apparatus of claim 13, wherein:
the at least one plausibility check comprises at least one of a correlation plausibility check, a positional plausibility check, a dimensional plausibility check, an elevational plausibility check, a proximity plausibility check, a velocity plausibility check, a mobility plausibility check, or a consensus-based plausibility check, and
the at least one plausibility check is based on at least one threshold, the at least one threshold being set based on the determined context for the device.

17. The apparatus of claim 16, wherein:
the positional plausibility check comprises an acceptance range threshold check,
the acceptance range threshold check comprises comparing (1) a purported distance between the device and a transmitter of the V2X message, based on a reported position value obtained from the received V2X message and (2) an acceptance range threshold, and
the acceptance range threshold is set based on the determined context for the device.

18. The apparatus of claim 17, wherein:
the acceptance range threshold is adjusted to a first level upon the determined context for the device attaining a first value, and
the acceptance range threshold is adjusted to a second level upon the determined context for the device attaining a second value.

19. The apparatus of claim 16, wherein:
the proximity plausibility check comprises a sudden appearance check,
the sudden appearance check comprises one or more tests, based on one or more sudden appearance test thresholds, to postulate that a transmitter of the V2X message has suddenly appeared, and
the one or more sudden appearance test thresholds are set based on the determined context of the device.

20. The apparatus of claim 13, wherein the processor is configured to weigh and combine the plurality of plausibility outputs by applying a weighted majority vote.

21. The apparatus of claim 13, wherein the processor is further configured to:
select the plurality of plausibility checks to be performed, based on the determined context for the device;
disable one or more modules to preclude one or more other plausibility checks from being performed.

22. The apparatus of claim 13, wherein:
the at least one set of weights comprises a plurality of sets of weights,
the at least one misbehavior detection comprise a plurality of misbehavior detections,
each misbehavior detection from the plurality of misbehavior detections is based on a different combined, weighted plausibility indicator value and utilizes a different set of weights from the plurality of sets of weights.

23. The apparatus of claim 13, wherein the device is part of an ego vehicle.

24. The apparatus of claim 13, wherein the V2X message is received from a remote vehicle.

25. A system for V2X misbehavior detection at a device comprising:
means for performing context detection to generate a determined context for the device;
means for performing a plurality of plausibility checks to generate a plurality of plausibility outputs, wherein at least one plausibility check of the plurality of plausibility checks is performed based on inputs including (1) a reported value obtained from a received V2X message and (2) the determined context for the device;
means for weighing and combining the plurality of plausibility outputs, by applying at least one set of weights based on the determined context for the device, to generate at least one combined, weighted plausibility indicator value; and
means for performing at least one misbehavior detection based on the at least one combined, weighted plausibility indicator value, to generate at least one misbehavior detection result.

26. The system of claim 25, wherein the determined context for the device comprises a multi-dimensional value.

27. The system of claim 25, wherein the means for performing the context detection to generate the determined context for the device comprises:
means for receiving a plurality of contextual inputs;
means for receiving a prior determined context for the device via a feedback path; and
means for generating the determined context for the device based on the plurality of contextual inputs and the prior determined context for the device.

28. A non-transitory computer-readable medium containing instruction therein for execution by one or more processing units for V2X misbehavior detection at a device, comprising instructions to:
perform context detection to generate a determined context for the device;
perform a plurality of plausibility checks to generate a plurality of plausibility outputs, wherein at least one plausibility check of the plurality of plausibility checks is performed based on inputs including (1) a reported value obtained from a received V2X message and (2) the determined context for the device;
weigh and combine the plurality of plausibility outputs, by applying at least one set of weights based on the determined context for the device, to generate at least one combined, weighted plausibility indicator value; and
perform at least one misbehavior detection based on the at least one combined, weighted plausibility indicator value, to generate at least one misbehavior detection result.

29. The non-transitory computer-readable medium of claim 28, wherein the determined context for the device comprises a multi-dimensional value.

30. The non-transitory computer-readable medium of claim 28, wherein the instruction to perform the context detection to generate the determined context for the device comprises instructions to:
receive a plurality of contextual inputs;
received a prior determined context for the device via a feedback path; and
generate the determined context for the device based on the plurality of contextual inputs and the prior determined context for the device.
